(19) United States
(12) Patent Application Publication
(10) Pub. No.: US 2014/0283391 A1
(43) Pub. Date: Sep. 25, 2014

(54) POWER TOOL

(71) Applicant: MAKITA CORPORATION, (US)

(72) Inventors: Ryoji ZAMA, Irvine, CA (US); Dennis STAUCH, Wilsonville, OR (US); Al RODRIGUEZ, Buena Park, CA (US); Louie MONTES, Los Angeles, CA (US); Martin CARDENAS, Corona, CA (US)

(21) Appl. No.: 13/847,108

(22) Filed: Mar. 19, 2013

(51) Int. Cl. A01G 3/053

(52) U.S. Cl. CPC A01G 3/053
USPC 30/208

(57) ABSTRACT

A hedge trimmer is provided and may include a first member having a plurality of blades, a second member having a plurality of blades that slide relative to the plurality of blades of the first member, a driver that drives at least one of the plurality of blades of the first member and the plurality of blades of the second member and a plate-shape member that projects upward from an upper surface side of one of the first member and the second member.

### TECHNICAL FIELD

The present application relates to power tools including but not limited to a hedge trimmer having blades that slide reciprocally relative to one another.

### DESCRIPTION OF RELATED ART

Conventional hedge trimmers are known to include a housing frame, a pair of shear blades, an engine that drives the pair of shear blades to reciprocally slide relative to one another, and a crank mechanism that converts rotational motion of the engine into the reciprocal linear-sliding motion of the pair of shear blades. The housing frame supports the engine and the crank mechanism and includes a grip to be grasped by a user for a hedging operation. The reciprocal linear-sliding motion of the blades enables the hedge trimmer to trim plants or the like that are caught between the reciprocating blades during the hedging operation.

However, during the hedging operation, the cut portions of the plants end up scattered across a wide area resulting in the cut portions remaining in the trimmed plants or scattered along the ground. Such scattering results in a more tedious and lengthy clean-up after the hedging operation. Thus, the need exists to control the scattering direction and the landing position of the cut portions from the trimmed plant.

A hedge trimmer including a leaf receiver is disclosed, e.g., in JP2008-307058. The leaf receiver is designed to catch some cut portions of trimmed plants during the hedging operation. However, the leaf receiver cannot contain all of the cut portions of the trimmed plants, and thus there is a problem that the cut portions scatter across a wide area. In addition, as shown, e.g., in FIGS. 1 and 3 of JP2008-307058, the leaf receiver is mounted above the shear blades and extends outwardly in a projecting direction of the blades so that at least one of the right side or left side of the blades is covered by the leaf receiver. Therefore, in a case where the leaf receiver plate is mounted to the hedge trimmer, there is an additional problem that the hedging operation can only be performed from one direction.

### SUMMARY OF THE INVENTION

Accordingly, the present application discloses a hedge trimmer capable of controlling the scattering of cut portions of trimmed plants and enabling multidirectional use during a hedging operation.

According to a non-limiting feature of the present disclosure, a hedge trimmer is provided. The hedge trimmer may include a first member having a plurality of blades, a second member having a plurality of blades that slide relative to the blades of the first member, and a driver that drives at least one of the blades of the first member and the blades of the second member. A plate-shape member may also be provided. The plate-shaped member may project upward from an upper surface side of one of the first member and the second member.

According to another non-limiting feature of the present disclosure, the plate-shaped member may be positioned within ±15° of a vertical direction with respect to one of the first member and the second member.

According to yet another non-limiting feature of the present disclosure, a projection height of the plate-shaped member from one of the first member and the second member may be 30 mm to 300 mm.

According to still another non-limiting feature of the present disclosure, a height of the plate-shaped member at a distal end of the blade may be greater than a height of the plate-shaped member at a proximal side of the blade.

According to another non-limiting feature of the present disclosure, at least one recessed opening (i.e., a cut-through portion) may be provided along a lower portion of the plate-shaped member. The recessed opening may extend along a longitudinal length of the first and second member.

According to yet another non-limiting feature of the present disclosure, the cut-through portion may be positioned on the plate-shaped member at a position where the cut-through portion contacts one of the first member and the second member. A plurality of cut-through portions may also be provided at spaced intervals along the longitudinal length of the plate-shaped member.

According to still another non-limiting feature of the present disclosure, the plate-shaped member may be one of a perforated metal having a plurality of holes, a transparent resin plate, and a mesh plate of a woven wire-like material.

According to another non-limiting feature of the present disclosure, the plate-shaped member may be elastically resilient and flexible relative to at least one of the first member and the second member.

According to yet another non-limiting feature of the present disclosure, the blades of the first member may be formed on both left and right sides of the first member, and the blades of the second member may be formed on both left and right sides of the second member.

According to still another non-limiting feature of the present disclosure, both the blades of the first member and the blades of the second member may be driven by the driver.

According to another non-limiting feature of the present disclosure, the plate-shaped member may he attachable and detachable to one of the first member and the second member.

### BRIEF DESCRIPTION OF THE DRAWINGS

FIG. 1 shows a lateral view of a hedge trimmer according to a first, non-limiting embodiment.

FIG. 2 shows a perspective view of the hedge trimmer shown in FIG. 1.

FIG. 3 shows a disassembled view of an inner housing and an outer housing of the hedge trimmer shown in FIG. 2.

FIG. 4 shows a longitudinal cross-sectional view of the hedge trimmer shown in FIG. 1.

FIG. 5(a) shows a perspective view of a plate-shaped member according to a first, non-limiting embodiment.

FIG. 5(b) shows a perspective view of the plate-shaped member of FIG. 5(a) attached to the hedge trimmer shown in FIG. 2.

FIG. 6(a) shows a perspective view of a plate-shaped member according to a second, non-limiting embodiment.

FIG. 6(b) shows a perspective view of the plate-shaped member of FIG. 6(a) attached to the hedge trimmer shown in FIG. 2.

FIG. 7(a) shows a perspective view of a plate-shaped member according to a third, non-limiting embodiment.

FIG. 7(b) shows a perspective view of the plate-shaped member of FIG. 7(a) attached to the hedge trimmer shown in FIG. 2.

### DETAILED DESCRIPTION

Representative, non-limiting examples of the present invention will now be described in further detail with reference to the attached drawings. This detailed description is merely intended to teach a person of skill in the art further details for practicing the present teachings and is not intended to limit the scope of the disclosed embodiments. Furthermore, each of the additional features and teachings disclosed below may he utilized separately or in conjunction with other features and teachings to provide improved power tools, as well as methods for using and manufacturing the same.

Moreover, combinations of features and methods disclosed in the following detail description may not be necessary to practice the disclosed embodiments in the broadest sense, and are instead taught merely to particularly describe representative examples of the same. Furthermore, various features of the above-described and below-described representative examples, as well as the various independent and dependent claims, may be combined in ways that are not specifically and explicitly enumerated in order to provide additional useful embodiments of the present teachings.

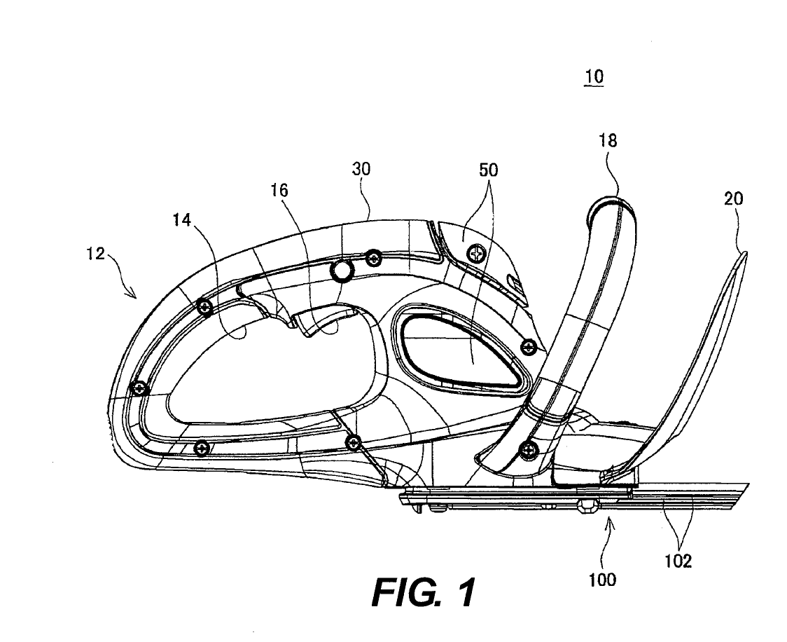

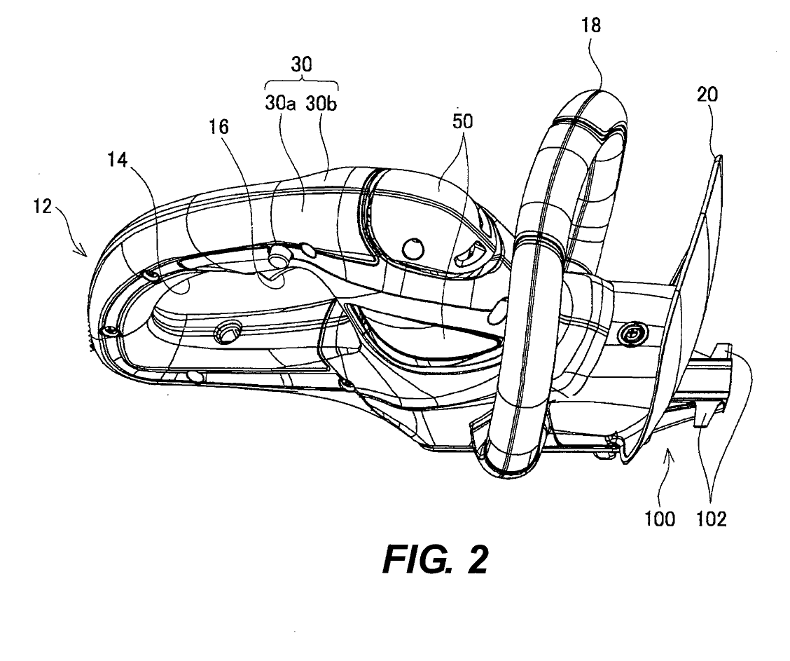

FIG. 1 and FIG. 2 show the external appearance of a hedge trimmer of a first representative, non-limiting embodiment of the present disclosure. The hedge trimmer 10 is a power tool employed for pruning hedges, bushes or the like. It should be noted that the hedge trimmer 10 is merely an exemplary implementation of the present disclosure; the present teachings may also be applied to a wide variety of other types of power tools, e.g., other trimmers, mowers, edgers, blowers and the like.

In the following description, directions such as front, rear (back), left, right, top, bottom, unless defined otherwise, are expressed with respect to the main body of the hedge trimmer when held in its usual or normal orientation during operation. For example, the “front”, “rear”, “top” and “bottom” directions refer to directions to the right side (towards where a blade assembly 100 is arranged), the left side (towards where a power source (not shown) is connected), the upper side and the lower side as respectively shown, e.g., in FIG. 1.

As shown in FIGS. 1 and 2, the hedge trimmer 10 includes a main body 12, and a blade assembly 100 attached to the main body 12.

The blade assembly 100 is fixed to the main body 12 and is detachable from the main body 12. The blade assembly 100 includes a pair of shear blades 102 (i.e., a first member and a second member). A front portion of the shear blades 102 is omitted from FIG. 1 for clarity purposes, although FIG. 2 shows that the pair of shear blades 102 extends forwardly along a longitudinal length of the hedge trimmer 10. A plurality of cutting portions is formed in a comb or toothed shape along a longitudinal length of the pair of shear blades 102. The pair of shear blades 102 trims hedges by reciprocally moving relative to each other along a linear path. The structure of the shear blades 102 may be the same as commonly known shear blades, and thus a detailed explanation thereof is being omitted herein.

The main body 12 includes an outer housing 30. The outer housing 30 may be made of a plastic material, although part or all of the housing may be made from, e.g., metal, ceramic, wood or another material. The outer housing 30 includes a right wall housing 30a and a left wall housing 30b (see FIG. 2). The outer housing 30 also includes a main grip 14 and a front grip 18 for a user to grip during an operation of the hedge trimmer 10.

The main grip 14 accommodates a trigger switch 16. The trigger switch 16 is the starting switch for a motor of the hedge trimmer 10. The user may grasp the main grip 14 and the front grip 18, and perform the task of trimming with the hedge trimmer 10 by operating the trigger switch 16 with the user's index finger. A chip guard 20 is also provided on a front portion of the outer housing 30. The chip guard 20 prevents pieces of cut branches and leaves from being ejected towards the user during operation.

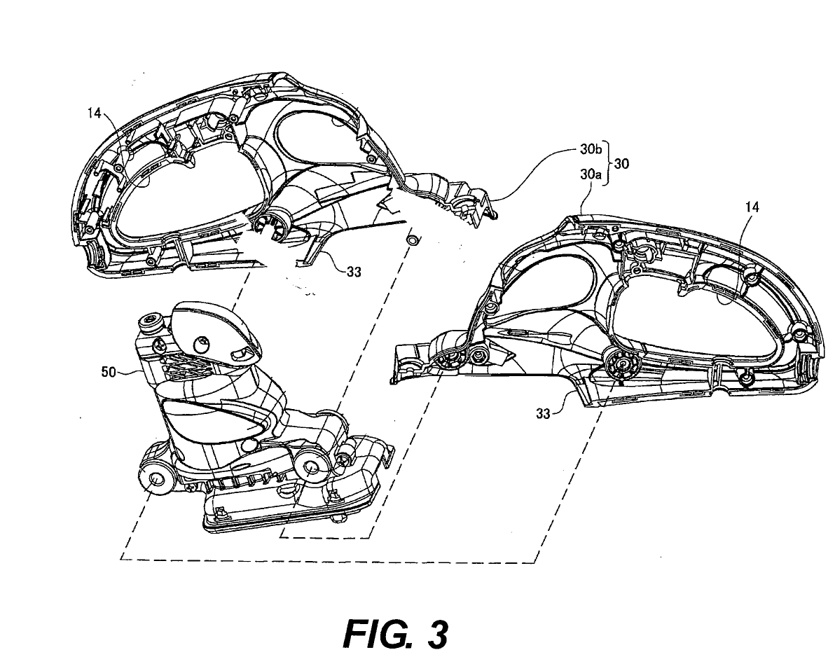

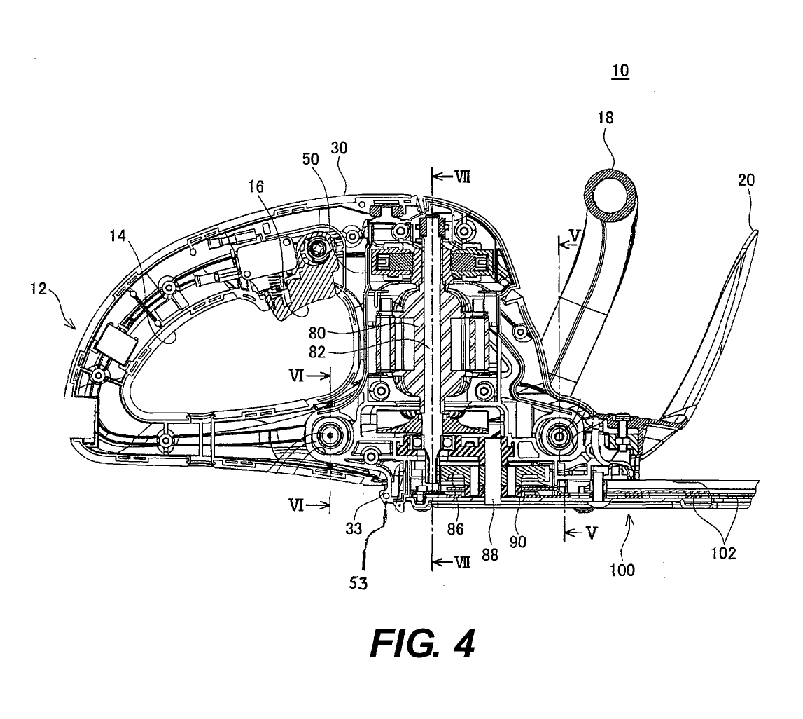

FIG. 3 shows the right wall housing 30a and the left wall housing 30b of the outer housing 30 in a disassembled state (exploded view). FIG. 4 shows a longitudinal cross-sectional view of the hedge trimmer 10. As shown in FIGS. 3 and 4, an inner housing 50 is housed in the interior of the outer housing 30. Thus, the main body 12 has a dual structure housing 30, 50.

As shown in FIG. 4, the blade assembly 100 described above is attached to a lowermost portion 53 of the inner housing 50. The lowermost portion 53 of the inner housing 50 downwardly and outwardly extends from a bottom opening 33 formed in a bottom portion of the outer housing 30. That is, the lowermost portion 53 of the inner housing 50 is exposed by, and in this embodiment also protrudes outwardly from, the bottom opening 33 of the outer housing 30 so as to allow the blade assembly to be operatively connected thereto.

As shown in FIG. 4, housed within the inner housing 50 are: a motor 80 for driving the pair of shear blades 102, a reduction gear 86 that is engaged with a motor shaft 82 of the motor 80, a crank cam 90 that is coaxially fixed with the reduction gear 86, and a cam shaft 88 that rotatably supports the reduction gear 86 and the crank cam 90. The crank cam 90 is engaged with the reduction gear 86 via crank pins at an upper end thereof, and is engaged with the pair of shear blades 102 from a lower end thereof, and converts the rotational motion of the motor 80 into linear reciprocal motion of the pair of shear blades 102. When the trigger switch 16 noted above is operated, electric power is supplied to the motor 80, and the motor 80 begins to rotate. When the motor 80 rotates, the crank cam 90 rotates, and the two shear blades 102 thereby reciprocally move along respective linear paths to perform the hedging operation.

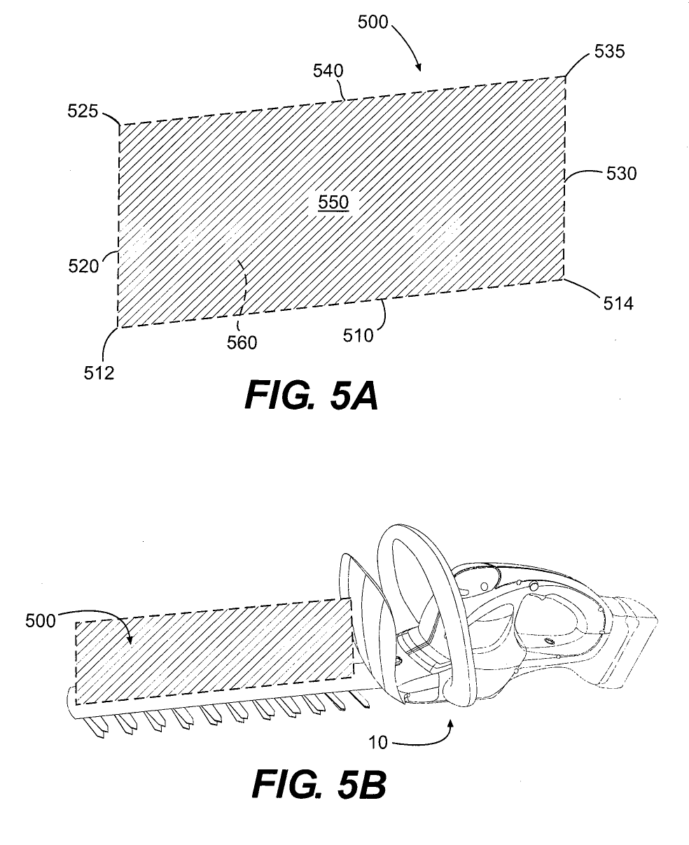

As shown in FIGS. 5(a) and 5(b), the hedge trimmer 10 may include a plate-shaped member 500 configured for attachment to an upper surface side of one of the shear blades 102 (the first member and the second member). The plate-shaped member 500 is generally rectangular, but it is contemplated that the plate-shaped member 500 may take on any number of polygonal shapes conducive to controlling the scattering of cut portions of trimmed plants and enabling multidirectional use during the hedging operation. The plate-shaped member 500 is also configured to project upward from one of the shear blades 102 and to extend along the longitudinal length direction of the hedge trimmer 10 from the main body 12 toward a front (or distal) end of the shear blades 102.

The plate-shaped member 500 may have a length that generally corresponds to the longitudinal length of the shear blades 102. As such, the plate-shaped member 500 can generally extend along the entire length of the shear blades 102. It is also contemplated that the plate-shaped member 500 may have a length shorter than the length of the shear blades 102. As such, the plate-shaped member 500 can partially extend along the longitudinal length of the shear blades 102 and is movably securable at a plurality of positions along the longitudinal length of the shear blades 102. This type of configuration gives an operator the ability to customize the trimmer for a particular operation and enhances the functionality of the hedge trimmer during operation.

As shown in FIG. 5(a), a plurality of edges surfaces define the generally rectangular plate-shaped member 500. In particular, an attachment edge surface 510, a leading edge surface 520, a rear edge surface 530 and an upper edge surface 540 are provided. The attachment edge surface 510 extends along a lower side of the plate-shaped member 500. The attachment edge surface 510 includes a leading end side corner surface 512 and a rear end side corner surface 514. The leading edge surface 520 extends from the leading end side corner surface 512 of the attachment edge surface 510 and projects upwardly toward an upper leading edge corner surface 525. The rear edge surface 530 extends from the rear end side corner surface 514 of the attachment edge surface 510 and projects upwardly toward an upper rear edge corner surface 535. The upper edge surface 540 extends between the upper leading edge corner surface 525 and the upper rear edge corner surface 535.

It is noted that a projection height of the leading edge surface 520 and a projection height of the rear edge surface 530 from the attachment edge surface 510 to the upper edge surface 540 are generally the same. It is contemplated that these projection heights may be between 30 mm to 300 mm.

The plate-shaped member 500 further includes a first planar surface 550 and a second planar surface 560. These surfaces are defined by and extend between each of the above-noted edge and corner surfaces.

As shown in FIG. 5(b), the plate-shaped member 500 is positioned in a direction generally perpendicular to the upper surface of one of the shear blades 102 (i.e., a direction generally vertical relative to the longitudinal direction of the hedge trimmer). The plate-shaped member 500 may also be positioned within ±15° of the vertical direction with respect to the shear blades 102. This configuration enables the operator to enhance the functionality of the hedge trimmer 10. That is, depending on the orientation of the plate-shaped member 500 (when attached to the hedge trimmer 10) and the cutting direction of the hedge trimmer 10, the plate-shaped member 500 functions to collect or deflect debris and functions to control the scattering of the cut portions of the trimmed plants.

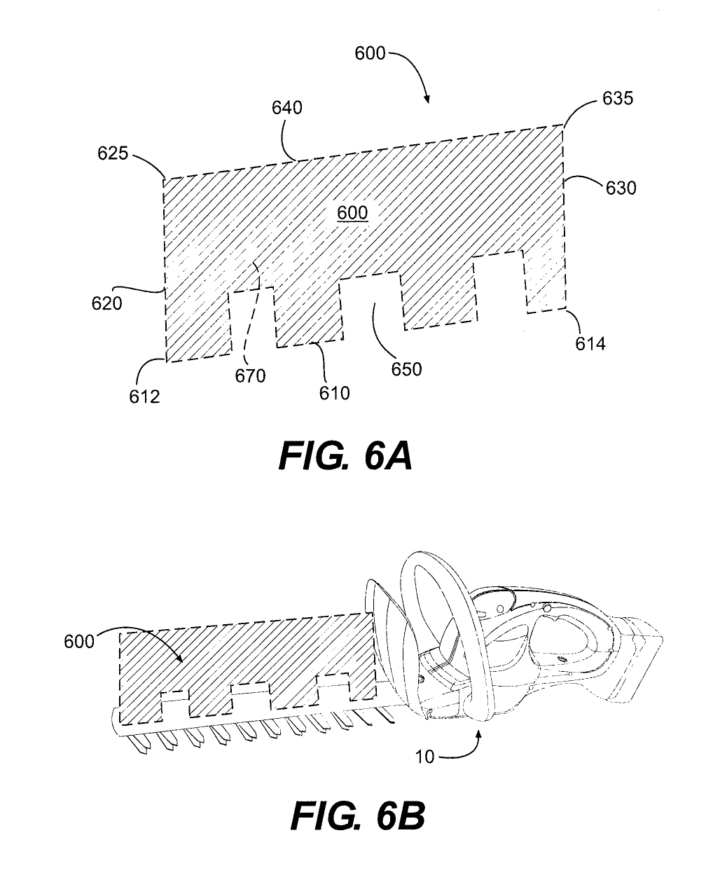

As shown in FIGS. 6(a) and 6(b), a plate-shaped member 600 is shown. The plate-shaped member 600 is similar to the plate-shaped member of FIGS. 5(a) and 5(b) and includes an attachment edge surface 610, a leading edge surface 620, a rear edge surface 630 and an upper edge surface 640. The attachment edge surface 610 extends along a lower side of the plate-shaped member 600. The attachment edge surface 610 includes a leading end side corner surface 612 and a rear end side corner surface 614. The leading edge surface 620 extends from the leading end side corner surface 612 of the attachment edge surface 610 and projects upwardly toward an upper leading edge corner surface 625. The rear edge surface 630 extends from the rear end side corner surface 614 of the attachment edge surface 610 and projects upwardly toward an upper rear edge corner surface 635. The upper edge surface 640 extends between the upper leading edge corner surface 625 and the upper rear edge corner surface 635.

It is noted that a projection height of the leading edge surface 620 and a projection height of the rear edge surface 630 from the attachment edge surface 610 to the upper edge surface 640 are generally the same. It is contemplated that these projection heights may be between 30 mm to 300 mm.

The plate-shaped member 600 further includes a first planar surface 660 and a second planar surface 670. These surfaces are defined by and extend between each of the above-noted edge and corner surfaces (as well as a plurality of cut-through portions discussed in detail below).

As shown in FIG. 6(a), the plate-shaped member 600 also includes a plurality of cut-through portions 650 (e.g., recessed openings) provided at spaced intervals extending along the attachment edge surface 610 in the longitudinal direction of the plate shaped member 600. The cut-through portions 650 are positioned on the plate-shaped member 600 at a position where the attachment edge surface 610 would otherwise contact the upper surface of one of the shear blades 102. In this regard, it is noted that the attachment edge surface 610 contacts the upper surface of one of the shear blades 102 at spaced intervals along the longitudinal length of the shear blades 102 and in an alternating manner with the cut-through portions 650.

The cut-through portions 650 further enhance the functionality of the hedge trimmer 10. For example, depending on the orientation of the plate-shaped member 600 (when attached to the hedge trimmer 10) and the cutting direction of the hedge trimmer 10, the cut-through portions 650 serve as windows to improve visibility for an operator to more accurately control the cutting action of the hedge trimmer 10. The cut-through portions 650 also enable an operator to more securely grip the plate-shaped member 600 during installation and removal from the hedge trimmer 10. In addition, the cut-through portions 650 reduce the overall weight of the plate-shaped member 600, which in turn enables the operator to operate the hedge trimmer 10 for an extended period of time. It is further noted that the reduction in weight also aids in the ease of installation and storage of the component. Lastly, while a plurality of cut-through portions 650 is shown, a single cut-through portion is also contemplated.

As shown in FIG. 6(b), the plate-shaped member 600 is positioned in a direction generally perpendicular to the upper surface of one of the shear blades 102 (i.e., a direction generally vertical relative to the longitudinal direction of the hedge trimmer). The plate-shaped member 600 may also be positioned within ±15° of the vertical direction with respect to the shear blades 102. This configuration again enables the operator to enhance the functionality of the hedge trimmer 10. That is, depending on the orientation of the plate-shaped member 600 (when attached to the hedge trimmer 10) and the cutting direction of the hedge trimmer 10, the plate-shaped member 600 functions to collect or deflect debris and functions to control the scattering of the cut portions of the trimmed plants.

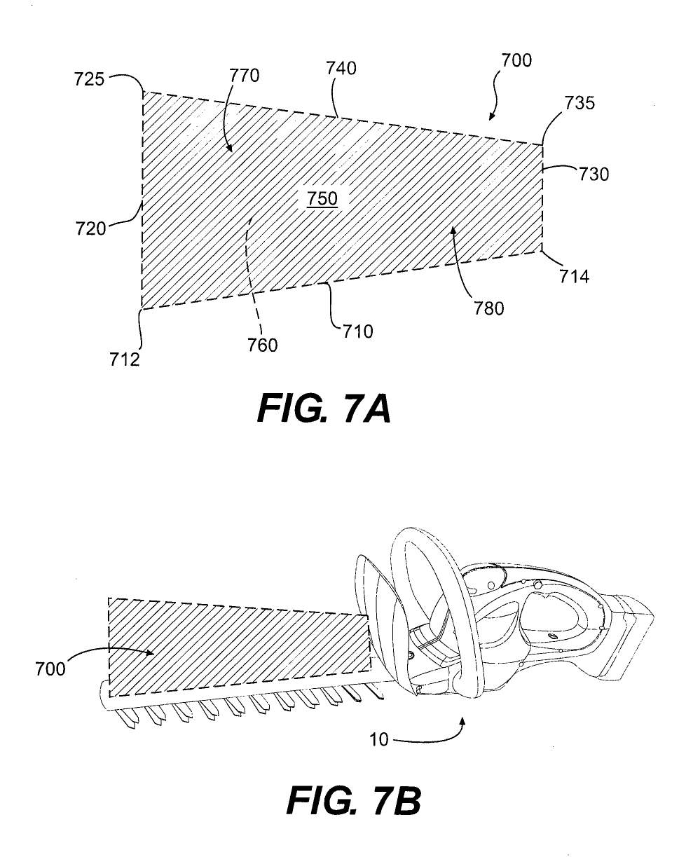

As shown in FIGS. 7(a) and 7(b), a plate-shaped member 700 is shown. The plate-shaped member 700 is similar to the plate-shaped members of FIGS. 5 and 6 and includes an attachment edge surface 710, a leading edge surface 720, a rear edge surface 730 and an upper edge surface 740. The attachment surface 710 extends along a lower side of the plate-shaped member 700. The attachment edge surface 710 includes a leading end side corner surface 712 and a rear end side corner surface 714. The leading edge surface 720 extends from the leading end side corner surface 712 of the attachment edge surface 710 and projects upwardly toward an upper leading edge corner surface 725. The rear edge surface 730 extends from the rear end side corner surface 714 of the attachment edge surface 710 and projects upwardly toward an upper rear edge corner surface 735. The upper edge surface 740 extends between the upper leading edge corner surface 725 and the upper rear edge corner surface 735.

The plate-shaped member 700 further includes a first planar surface 750 and a second planar surface 760. These surfaces are defined by and extend between each of the above-noted edge and corner surfaces.

As shown in FIG. 7(a), a projection height of the plate-shaped member 700 from the attachment edge surface 710 to the upper leading edge corner surface 725 is greater than a projection height of the plate-shaped member 700 from the attachment surface 710 to the upper rear edge corner surface 735. It is contemplated that these projection heights may be between 30 mm to 300 mm. Because of the height difference, the upper edge surface 740 is sloped downward in a direction from the upper leading edge corner surface 725 toward the upper rear edge corner surface 735, thereby creating a wide portion area 770 and a narrow portion area 780 on the plate-shaped member 700.

This configuration enhances the functionality of the hedge trimmer 10. For example, depending on the orientation of the plate-shaped member 700 (when attached to the hedge trimmer 10) and the cutting direction of the hedge trimmer 10, the extended height of the upper leading edge corner surface 725 improves the functionality of the hedge trimmer 10. For example, the wide portion area 770 of the plate-shaped member 700 functions to collect difficult-to-reach plants and debris, as well as functions to control the scattering of the cut portions of the trimmed plants. Further, the downward sloping upper edge surface 740 may serve as a multi-directional guide for the cut portions of the trimmed plants.

As shown in FIG. 7(b), the plate-shaped member 700 is positioned in a direction generally perpendicular to the upper surface of one of the shear blades 102 (i.e., a direction generally vertical relative to the longitudinal direction of the hedge trimmer). The plate-shaped member 700 may also be positioned within ±15° of the vertical direction with respect to the shear blades 102. This configuration enables the operator to further enhance the functionality of the hedge trimmer 10. For example, depending on the orientation of the plate-shaped member 700 (when attached to the hedge trimmer 10) and the cutting direction of the hedge trimmer 10, the plate-shaped member 700 functions to collect or deflect debris and functions to control the scattering of the cut portions of the trimmed plants.

Each of the plate-shaped members 500, 600 and 700 may be made from a plurality of materials for durability and usability for a given hedging operation. For example, the plate-shaped members 500, 600 and 700 may be any one of a perforated metal having a plurality of holes, a transparent resin plate and a mesh plate of a woven wire-like material or any combination of the same. It is also contemplated that the plate-shaped material may be made of other known materials used in the field of power tools.

Each of the plate-shaped members 500, 600 and 700 may also be configured to be elastically resilient and flexible relative to the shear blades 102. This construction prevents the plated-shaped members 500, 600 and 700, e.g., from being pierced by a cut portion of the trimmed plants or getting snagged on a rough edge of a cut branch. The flexibility also enables the plate-shaped members 500, 600 and 700 to have increased manipulability when controlling the scattering of the cut portions of the trimmed plants and improved multi-directional cutting, as well as further enhances durability of the plate-shaped members.

Each of the plate-shaped members 500, 600 and 700 may be attachable to and detachable from one of the shear blades 102 via a variety of attachment mechanisms. For example, the plate-shaped members 500, 600 and 700 may be attachable to and detachable from one of the shear blades 102 via any one of a known snap fit construction, a tongue and groove construction, and other fastener construction so that the plate-shaped members 500, 600 and 700 are reliably secured to the shear blades 102 for the hedging operation, as well as reliably removable for replacement, repair or storage.

Although the invention has been described with reference to several exemplary embodiments, which can be combined in any suitable manner, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods and uses such as are within the scope of the appended claims.

1. A hedge trimmer comprising:
a first member having a plurality of blades;
a second member having a plurality of blades that slide relative to the plurality of blades of the first member;
a driver that drives at least one of the plurality of blades of the first member and the plurality of blades of the second member; and
a plate-shape member that projects upward from an upper surface side of one of the first member and the second member.

2. The hedge trimmer according to claim 1, wherein the plate-shaped member is positioned within ±15° of a vertical direction with respect to one of the first member and the second member.

3. The hedge trimmer according to claim 1, wherein a projection height of the plate-shaped member from one of the first member and the second member is between 30 mm to 300 mm.

4. The hedge trimmer according to claim 1, wherein a height of the plate-shaped member at a distal end of one of the first member and the second member is greater than a height of the plate-shaped member at a proximal end of the one of the first member and the second member.

5. The hedge trimmer according to claim 1, wherein the plate-shaped member includes at least one cut-through portion provided along a lower side portion thereof and extending therethrough.

6. The hedge trimmer according to claim 5, wherein the at least one cut-through portion is provided on the plate-shaped member at a position where the cut-through portion contacts one of the first member and the second member.

7. The hedge trimmer according to claim 5, wherein the at least one cut-through portion is a plurality of cut-through portions provided at spaced intervals along a longitudinal length of the plate-shaped member.

8. The hedge trimmer according to claim 1, wherein the plate-shaped member is one of a perforated metal having a plurality of holes, a transparent resin plate, and a mesh plate of a woven wire-like material.

9. The hedge trimmer according to claim 1, wherein the plate-shaped member is elastically resilient and flexible relative to at least one of the first member and the second member.

10. The hedge trimmer according to claim 1, wherein the plate-shaped member is attachable to and detachable from one of the first member and the second member.
